(19) United States
(12) Patent Application Publication
(10) Pub. No.: US 2026/0127124 A1
(43) Pub. Date: May 7, 2026

(54) INTERFACE SYSTEM AND REMOTE I2C SLAVE DEVICE DATA WRITING METHOD

(71) Applicant: NOREL SYSTEMS LIMITED, Tianjin (CN)

(72) Inventors: Yuanlong WANG, Tianjin (CN); Hui Wang, Tianjin (CN)

(21) Appl. No.: 19/434,266

(22) Filed: Dec. 29, 2025

Related U.S. Application Data
(63) Continuation of application No. PCT/CN2024/119278, filed on Sep. 18, 2024.

(30) Foreign Application Priority Data
Dec. 6, 2023 (CN) 202311669609.3

(51) Int. Cl. G06F 13/362; G06F 13/42

(52) U.S. Cl. CPC G06F 13/362; G06F 13/4282; G06F 2213/0016

(57) ABSTRACT

The present disclosure provides an interface system, comprising a master controller, an interface module, a functional module, and a remote I2C slave device; the master controller is connected to the interface module; the interface module is connected to the functional module, and the functional module is connected to the remote I2C slave device. The present disclosure is applicable for long-distance data transmission, with a high data transfer speed.

### CROSS-REFERENCE TO RELATED APPLICATION

This application is a continuation application of International Patent Application No. PCT/CN 2024/119278, filed on Sep. 18, 2024, which itself claims priority to and benefit of Chinese Patent Application No. 202311669609.3 filed on Dec. 6, 2023 in the State Intellectual Property Office of P. R. China. The disclosure of each of the above applications is incorporated herein by reference in its entirety.

### TECHNICAL FIELD

The present disclosure relates to the field of communication technologies, particularly to an interface system and a remote I2C slave device data writing method.

### BACKGROUND

The I2C bus is a simple, bidirectional serial bus developed by Philips. Devices interconnected via the I2C bus are called I2C devices, and the interface through which an I2C device is connected to the I2C bus is called an I2C interface. The I2C bus has become a de facto international standard, and the design specifications of the I2C bus and its protocol (referred to as the standard I2C specification) are typically based on the descriptions in the document THE I2C-BUS SPECIFICATION VERSION 2.1 JANUARY 2000.

The I2C interface includes an I2C clock line (usually named SCL) and an I2C data line (usually named SDA). The I2C master controller is connected to one or more I2C slave devices via the I2C clock line and data line. The I2C master controller drives the I2C clock line, initiates I2C write or read operations, and determines whether data transmission is success through acknowledgment bits. Bit errors on the bus caused by signal interference or other factors cannot be detected by the I2C slave devices.

The electrical characteristics of the I2C interface require devices participating in I2C communication to share a common ground; otherwise, transmission is impossible. Therefore, I2C communication is unapplicable for application scenarios with long transmission distances or significant signal interference. To address this issue, devices for forwarding I2C data are often added to the I2C bus, but introducing forwarding devices introduces new problems:
The I2C communication mechanism requires the I2C master controller to receive an acknowledgment bit from the I2C slave device for every byte sent. A low-level acknowledgment bit is an I2C ACK, while a high-level one is an I2C NAK. In the prior art, every byte sent by the I2C master controller is transmitted to the final data-receiving module (referred to as the functional module in the present disclosure), and the acknowledgment bit is generated by the functional module and sent back to the I2C master controller. The slow acknowledgment speed of the transmission system results in slow transmission speeds.

SPI (Serial Peripheral Interface) is a high-speed, full-duplex, synchronous communication bus that uses only four wires on the chip's pins, saving pin resources and providing convenience for PCB layout. SPI typically consists of four signal lines: SPI_CSN, SPI_CK, SPI_MOSI, and SPI_MISO. The SPI master controller is connected to the SPI interface module through these four signal lines, with the master controller acting as the SPI master device and the interface module as the SPI slave device. The master controller drives the SPI_CSN, SPI_CK, and SPI_MOSI signal lines, while the interface module receives these signals. Conversely, the interface module drives the SPI_MISO signal line, which the master controller receives. The interface module samples the data driven by the master controller on the SPI_MOSI signal line at the rising or falling clock edge of SPI_CK, while the master controller samples the data driven by the interface module on the SPI_MISO signal line at the same clock edges. In the SPI protocol, the master controller generates the clock edges on the SPI_CK signal line, and both the master controller and interface module sample data on SPI_MISO and SPI_MOSI at these edges, enabling bidirectional data transfer between them. The SPI_CSN signal line serves as the select signal; data transmission occurs only when SPI_CSN is low. One master controller can connect to a plurality of interface modules (i.e., one master to a plurality of slaves), sharing SPI_CK, SPI_MOSI, and SPI_MISO signal lines. However, each interface module has its own SPI_CSN input. When an interface module's SPI_CSN is high, it does not drive the SPI_MISO line (its driver outputs a Hi-Z state). Only when SPI_CSN is low does the interface module drive SPI_MISO. When a plurality of interface modules are connected to one master, only one module's SPI_CSN is low at any time, preventing conflicts from simultaneous driving of SPI_MISO by a plurality of modules.

When an SPI master controller is connected to only one SPI interface module, this SPI interface module can drive the SPI_MISO signal line at any time without causing conflicts. In this case, there may be no SPI_CSN signal line between the SPI master controller and the SPI interface module. That is, when an SPI master controller is connected to only one SPI interface module, the SPI master controller and the SPI interface module can be connected solely through the SPI_CK signal line, SPI_MOSI signal line, and SPI_MISO signal line.

During long-distance data transmission, the process is generally based on a mode of sending a command packet and then receiving a feedback packet. The feedback packet contains status information about the execution of the command. For read commands, the feedback packet may also include read data. In the existing SPI protocol, bidirectional data transmission between the SPI master controller and the SPI interface module is achieved by sampling data on the SPI_MISO and SPI_MOSI signal lines at the rising or falling edge of the clock on the SPI_CK signal line. However, this data transmission can be considered a form of data stream transmission and is not applicable for long-distance data transmission.

### SUMMARY

To address the issue of I2C and SPI buses being unapplicable for long-distance data transmission in the prior art, an object of the present disclosure is to provide an interface system. The interface system comprises a master controller, an interface module, a functional module and a remote I2C slave device; and

the master controller is connected to the interface module, the interface module is connected to the functional module, and the functional module is connected to the remote I2C slave device.

Another object of the present disclosure is to provide a method for writing data to a remote I2C slave device. In this method, an interface system is used to write data to the remote I2C slave device. The method comprises:
the master controller sending a write command packet to the interface module, and upon receiving the write command packet, the interface module forwarding the write command packet to the functional module,
wherein the write command packet contains a plurality of write commands, and the functional module receives the write command packet and executes the plurality of write commands contained therein, wherein a method for executing each write command is as follows:
the functional module sending an I2C START to the remote I2C slave device, then the functional module sending a remote I2C address byte to the remote I2C slave device, followed by the functional module sending the write command to the remote I2C slave device;
for each byte sent by the functional module to the remote I2C slave device, the functional module receiving an I2C acknowledgment bit from the remote I2C slave device and determining an execution result of the write command,
the functional module returning a write status packet to the interface module, comprising:
when the execution result of each write command in the write command packet is success, the functional module returning a write status packet with status information indicating success to the interface module;
when the execution result of at least one write command in the write command packet is failure, the functional module returning a write status packet with status information indicating failure to the interface module; and
the interface module returning the status information of the write status packet to the master controller.

Preferably, the functional module receives the write command packet and executes the write commands contained therein; and when a execution result of a write command is failure, the functional module stops executing subsequent write commands and returns a write status packet with status information indicating failure to the interface module.

Preferably, the master controller is an I2C master controller, and the interface module is an I2C interface module;
the I2C master controller is connected to the I2C interface module via an I2C clock line and an I2C data line; the I2C master controller initiates an I2C write operation to send the write command packet to the I2C interface module; and upon receiving the write command packet, the I2C interface module pulls down a level of the I2C clock line and forwards the write command packet to the functional module;
the functional module returns the write status packet to the I2C interface module, and the I2C interface module then relays the status information of the write status packet back to the I2C master controller, comprising:
when the I2C interface module receives the write status packet and the status information of the write status packet indicates success, the I2C interface module stops pulling down the level of the I2C clock line and returns an I2C ACK to the I2C master controller; and
when the I2C interface module receives the write status packet and the status information of the write status packet indicates failure, the I2C interface module stops pulling down the level of the I2C clock line and returns an I2C NAK to the I2C master controller.

Preferably, the master controller is an I2C master controller, and the interface module is an I2C interface module;
the I2C master controller is connected to the I2C interface module via an I2C clock line and an I2C data line; the I2C master controller initiates an I2C write operation to send the write command packet to the I2C interface module; and upon receiving the write command packet, the I2C interface mode forwards the write command packet to the functional module;
the functional module returns the write status packet to the I2C interface module, and the I2C interface module then relays the status information of the write status packet back to the I2C master controller, comprising:
after the I2C interface module receives the write command packet,
if a subsequent I2C operation initiated by the I2C master controller is an I2C write operation, and the I2C interface module receives the write status packet returned by the functional module with status information thereof indicating success, the I2C interface module proceeding to accept the subsequent I2C write operation initiated by the I2C master controller;
if the subsequent I2C operation initiated by the I2C master controller is an I2C write operation, and the I2C interface module receives the write status packet returned by the functional module to the I2C interface module with status information thereof indicating failure, then the I2C interface module returning an I2C NAK to the I2C master controller; and
if the subsequent I2C operation initiated by the I2C master controller is an I2C read operation, and the I2C interface module receives the write status packet returned by the functional module to the I2C interface module, then the I2C interface module returning the status information of the write status packet to the I2C master controller.

Preferably, the master controller is an SPI master controller, the interface module is an SPI interface module, and the SPI master controller is connected to the SPI interface module via a SPI_CK signal line, a SPI_MOSI signal line and a SPI_MISO signal line;
the SPI master controller generates a clock edge on the SPI_CK signal line and sends the write command packet to the SPI interface module via the SPI_MOSI signal line; the write command packet begins with a first identifier; and upon receiving the write command packet from SPI_MOSI, the SPI interface module forwards the write command packet to the functional module; and
the functional module returns the write status packet to the SPI interface module, and the SPI interface module returns the status information of the write status packet to the SPI master controller, comprising:
upon receiving the write status packet, when the SPI master controller generates a clock edge on SPI_CK, the SPI interface module sending a write feedback packet to the SPI master controller via the SPI_MISO signal line, wherein the write feedback packet begins with a second identifier and contains the status information comprised in the write status packet.

Preferably, the SPI master controller generates a clock edge on the SPI_CK signal line and reads the write feedback packet via the SPI_MISO signal line; and
if the SPI interface module does not receive the write status packet, the SPI interface module sends data unrecognizable as the write feedback packet to the SPI master controller via the SPI_MISO signal line.

Preferably, the SPI master controller generates a clock edge on the SPI_CK signal line and sends the write command packet to the SPI interface module via the SPI_MOSI signal line; and
then, the SPI master controller generates a clock edge on the SPI_CK signal line and reads the write feedback packet via the SPI_MISO signal line, and after sending the write feedback packet via SPI_MISO, the SPI interface module can continue to receive subsequent command packets.

Preferably, the write feedback packet is divided into a write success feedback packet and a write failure feedback packet;
the SPI master controller generates a clock edge on the SPI_CK signal line and reads the write feedback packet through the SPI_MISO signal line,
when the SPI interface module receives the write status packet and the status information contained in the write status packet indicates success, the SPI interface module sends the write success feedback packet through the SPI_MISO signal line, and the write success feedback packet begins with a third identifier; and
when the SPI interface module receives the write status packet and the status information contained in the write status packet indicates failure, the SPI interface module sends the write failure feedback packet through the SPI_MISO signal line, and the write failure feedback packet begins with a fourth identifier.

Preferably, the functional module comprises a remote I2C address register, and an I2C address contained in the remote I2C address byte sent by the functional module to the remote I2C slave device is a remote I2C address stored in the remote I2C address register.

Preferably, the write command packet contains a remote I2C address, and the I2C address contained in the remote I2C address byte sent by the functional module to the remote I2C slave device is the remote I2C address contained in the write command packet.

Preferably, the functional module comprises a remote I2C address register and a remote I2C address selection module, and the I2C address contained in the remote I2C address byte sent by the functional module to the remote I2C slave device, as instructed by the remote I2C address selection module, is derived from either the remote I2C address stored in the remote I2C address register or the remote I2C address contained in the write command packet.

Preferably, the plurality of write commands in the write command packet each contain a remote I2C address, and the remote I2C address contained in the remote I2C address byte sent by the functional module to the remote I2C slave device is derived from the remote I2C address contained in each respective write command.

The interface system and the remote I2C slave device data writing method provided by the present disclosure are applicable for long-distance data transmission and offer high-speed data transfer.

### BRIEF DESCRIPTION OF DRAWINGS

To more clearly illustrate the embodiments of the present disclosure or technical solutions in the prior art, the drawings required for describing the embodiments or the prior art will be briefly introduced below. Obviously, the drawings in the following description are some embodiments of the present disclosure. For those of ordinary skill in the art, other drawings can also be obtained from these drawings without creative effort.

FIG. 1 schematically shows a structural block diagram of an interface system according to the present disclosure.

FIG. 2 shows a schematic diagram of the data structure of a write command packet in the present disclosure.

FIG. 3 shows a structural block diagram of an interface system where the master controller is an I2C master controller and the interface module 25 is an I2C interface module according to the present disclosure.

FIG. 4 shows a timing diagram of an I2C write operation in the present disclosure.

FIG. 5 shows a timing diagram of an I2C read operation in the present disclosure.

FIG. 6 shows a timing diagram of continuous I2C read/write operations in the present disclosure.

FIG. 7 shows a timing diagram of initiating an I2C write operation to send a write command packet (or read command packet) in the present disclosure.

FIG. 8 shows a timing diagram of initiating an I2C write operation to send a write command packet with successful status information in the write status packet according to an embodiment of the present disclosure.

FIG. 9 shows a timing diagram of initiating an I2C write operation to send a write command packet with failed status information in the write status packet according to an embodiment of the present disclosure.

FIG. 10 shows a timing diagram of initiating an I2C write operation to send a write command packet with successful status information in the write status packet according to another embodiment of the present disclosure.

FIG. 11 shows a timing diagram of initiating an I2C write operation to send a write command packet with failed status information in the write status packet according to another embodiment of the present disclosure.

FIG. 12 shows a timing diagram of initiating an I2C write operation to send a write command packet followed by an I2C read operation according to another embodiment of the present disclosure.

FIG. 13 shows a structural block diagram of an interface system where the master controller is an SPI master controller and the interface module is an SPI interface module according to the present disclosure.

FIG. 14 shows a schematic diagram of the data structure of a write command packet when the master controller is an SPI master controller and the interface module is an SPI interface module according to the present disclosure.

FIG. 15 shows the timing diagram of the first embodiment of SPI data writing in the present disclosure.

FIG. 16 shows the timing diagram of the second embodiment of SPI data writing in the present disclosure.

FIG. 17 shows the timing diagram of the third embodiment of SPI data writing in the present disclosure.

FIG. 18 shows the timing diagram of the fourth embodiment of SPI data writing in the present disclosure.

FIG. 19 shows the timing diagram of the fifth embodiment of SPI data writing in the present disclosure.

FIG. 20 illustrates a schematic diagram of the functional module returning a write status packet with successful status information to the interface module in the present disclosure.

FIG. 21 shows the functional module returning a write status packet with failed status information to the interface module in one embodiment of the present disclosure.

FIG. 22 shows the functional module returning a write status packet with failed status information to the interface module in another embodiment of the present disclosure.

The meanings of the labels in the above figures are as follows:
5 100: Master controller; 100a: I2C Master controller; 100b: SPI master controller;
200: Interface module; 200a: I2C Interface module; 200b: SPI interface module;
SDA: I2C data line; SCL: I2C clock line;
S: represents the I2C START signal, where the corresponding I2C bus state is a high-to-low transition of SDA while SCL is high;
10 P: represents the I2C STOP signal, where the corresponding I2C bus state is a low-to-high transition of SDA while SCL is high;
Sr: the corresponding I2C bus state is the same as S;
Sr/P: the corresponding I2C bus state is Sr or P;
ADDR: I2C address;
R/W: indicates the read/write operation indicator bit. When this bit is R, it indicates a read operation; when this bit is W, it indicates a write operation;
R: indicates the read operation indicator bit, corresponding to the I2C bus state where SCL is high and SDA is high;
W: indicates the write operation indicator bit, corresponding to the I2C bus state where SCL is high and SDA is low;
BYTE: write operation data or read operation data, typically a multi-byte sequence. The content in parentheses following it indicates the byte's position in the sequence. Write command packets or read command packets are sent via write operation data, while read data or status information is retrieved via read operation data. Bytes with smaller sequence numbers are transmitted first;
A: indicates I2C ACK, corresponding to the I2C bus state where SCL is high and SDA remains low;
N: indicates I2C NAK, corresponding to the I2C bus state where SCL is high and SDA remains high;
STATUS: a byte containing status information, along with a sequence of I2C ACK/I2C NAK between bytes;
A/N: corresponds to the I2C bus state where SCL is high and SDA remains either high or low;
HOLD: SCL remains continuously low;
IDLE: the corresponding I2C bus state includes the following two possibilities:
   (1) Both SCL and SDA are high;
   (2) SCL and SDA may exhibit other level states, but no valid I2C operation occurs in these combinations. At the end of IDLE, both SCL and SDA are high;
SPI_CK: SPI_CK signal line; SPI_MOSI: SPI_MOSI signal line; SPI_MISO: SPI_MISO signal line; SPI_CSN: SPI_CSN signal line.

### DESCRIPTION OF EMBODIMENTS

To make the above and other features and advantages of the present disclosure clearer, the present disclosure is further described below with reference to the accompanying drawings. It should be understood that the specific embodiments provided herein are for the purpose of explaining to those skilled in the art and are exemplary only, not restrictive.

As shown in FIG. 1, according to an embodiment of the present disclosure, an interface system is provided, wherein the interface system includes a master controller 100, an interface module 200, a functional module 300, and a remote I2C slave device 400. The master controller 100 is connected to the interface module 200; the interface module 200 is connected to the functional module 300, and the functional module 300 is connected to the remote I2C slave device 400.

In the present disclosure, the interface module 200 can be connected to one or more functional modules 300, and the functional module 300 can also be connected to one or more remote I2C slave devices 400. The following description assumes the interface module 200 is connected to one functional module 300, and the functional module 300 is connected to one remote I2C slave device 400.

According to an embodiment of the present disclosure, a method for writing data to a remote I2C slave device is provided, using the interface system of the present disclosure to write data to the remote I2C slave device 400, including:
The master controller 100 sends a write command packet to the interface module 200. Upon receiving the write command packet, the interface module 200 forwards it to the functional module 300.

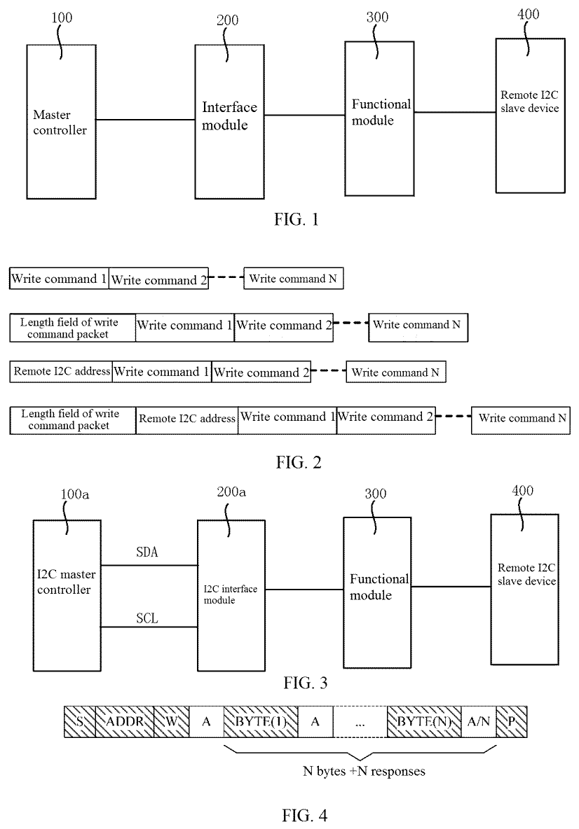

As shown in FIG. 2, the write command packet of the present disclosure contains a plurality of write commands. For example, the write command packet may include write command 1, write command 2, . . . , write command N.

The functional module 300 receives the write command packet and executes the plurality of write commands contained within it. The method for executing each write command is as follows:
The functional module 300 sends an I2C START to the remote I2C slave device 400, followed by the remote I2C address byte, and then the write command to the remote I2C slave device 400.

For each byte sent by the functional module 300 to the remote I2C slave device 400, the functional module 300 receives the I2C acknowledgment bit from the remote I2C slave device 400 and determines the execution result of the write command.

The functional module 300 returns a write status packet to the interface module 200, including:
When the execution result of every write command in the write command packet is success, the functional module 300 returns a write status packet with a status information indicating success to the interface module 200.

When the execution result of at least one write command in the write command packet fails, the functional module 300 returns a write status packet with a status information indicating failure to the interface module 200.

The interface module 200 returns the status information of the write status packet to the master controller 100.

In one embodiment, the functional module 300 receives the write command packet and executes the write commands within it. If the execution result of a write command fails, the functional module 300 stops executing subsequent write commands and returns a write status packet with a status information indicating failure to the interface module 200.

As shown in FIG. 3, in one embodiment, the master controller 100 is an I2C master controller 100a, and the interface module 200 is an I2C interface module 200a.

I2C The master controller 100a is connected to the I2C interface module 200a via the I2C clock line (SCL) and the I2C data line (SDA). The I2C master controller 100a initiates an I2C write operation to send the write command packet to the I2C interface module 200a. Upon receiving the write command packet, the I2C interface module 200a pulls the I2C clock line (SCL) level low and forwards the write command packet to the functional module 300.

The functional module 300 returns the write status packet to the I2C interface module 200a, which then relays the status information of the write status packet back to the I2C master controller 100a, including:
When the I2C interface module 200a receives the write status packet and its status information indicates success, it stops pulling the I2C clock line (SCL) level low and returns an I2C ACK to the I2C master controller 100a.

When the I2C interface module 200a receives the write status packet and its status information indicates failure, it stops pulling the I2C clock line (SCL) level low and returns an I2C NAK to the I2C master controller 100a.

As shown in FIG. 4, the I2C write operation includes the write address byte and the write data bytes (BYTE (1), . . . , BYTE(N), shaded). The write address byte is the first transmitted byte, containing the I2C address (ADDR) and the write operation indicator bit (W). According to the standard I2C specification, the write operation indicator bit (W) is set to low level.

In this embodiment, both the write address byte and the write data bytes are 8 bits, with the write address byte comprising a 7-bit I2C address (ADDR) and a 1-bit write operation indicator bit (W). This invention does not limit the bit count of the write address byte or the write data bytes; in other embodiments, they may have different bit counts.

When the I2C master controller 100a initiates an I2C write operation, it first drives the I2C clock line (SCL) and the I2C data line (SDA) according to the standard I2C specification to generate an I2C START signal(S), then sends the write address byte. The I2C interface module 200a drives the I2C data line (SDA) upon receiving the write address byte to generate an acknowledgment bit. Per the standard I2C specification, the acknowledgment bit can be an I2C ACK (I2C data line level low) or an I2C NAK (I2C data line level high).

When the acknowledgment bit for the write address byte is an I2C ACK, the I2C master controller 100a can proceed to send the write data bytes. The I2C interface module 200a drives the I2C data line (SDA) after receiving each write data byte to generate an acknowledgment bit, which can be an I2C ACK (I2C data line level low) or an I2C NAK (I2C data line level high).

According to the standard I2C specification, when transmitting the write address byte and write operation data byte, the I2C master controller 100a drives the I2C data line (SDA) to send the number of bits contained in the write address byte and write operation data byte. For each bit in the write address byte and write operation data byte, the I2C master controller 100a drives the I2C clock line (SCL) to generate a clock pulse.

According to the standard I2C specification, for the acknowledgment bit corresponding to the write address byte and the acknowledgment bit of the write operation data byte, the I2C master controller 100a also drives the I2C clock line (SCL) to generate a clock pulse. The I2C master controller 100a terminates the current write operation by sending the I2C STOP signal (P) or I2C START signal(S) as defined by the standard I2C specification.

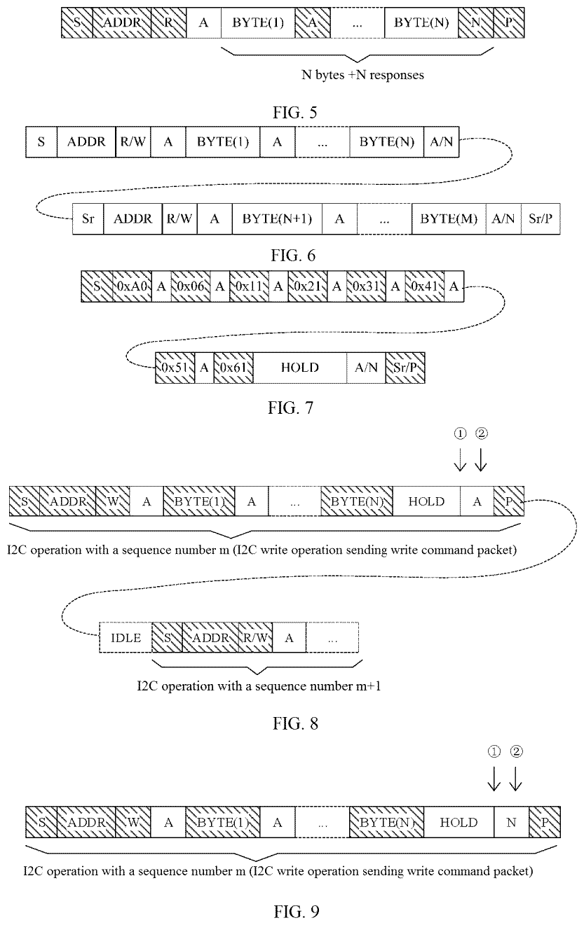

As shown in FIG. 5, the I2C read operation includes the read address byte and read operation data bytes (BYTE (1), . . . , BYTE(N), unshaded). The read address byte is the first byte sent by the I2C master controller 100a, while the read operation data bytes are sent by the I2C interface module 200a. The read address byte contains the I2C address (ADDR) and the read operation indicator bit (R). According to the standard I2C specification, the read operation indicator bit (R) is set to a high level.

In this embodiment, both the read address byte and the read operation data bytes are 8 bits, where the read address byte includes a 7-bit I2C address (ADDR) and a 1-bit read operation indicator bit (R). The present invention does not limit the number of bits in the read address byte and read operation data bytes; in other embodiments, they may have other bit lengths.

When the I2C master controller 100a initiates an I2C read operation, it first drives the I2C clock line and I2C data line according to the standard I2C specification to generate the I2C START signal(S), then sends the read address byte. After receiving the read address byte, the I2C interface module 200a drives the I2C data line to generate an acknowledgment bit. According to the standard I2C specification, the acknowledgment bit can be I2C ACK (I2C data line level low) or I2C NAK (I2C data line has a high level).

When the acknowledgment bit for the read address byte is I2C ACK, the I2C interface module 200a can return the read operation data bytes by driving the I2C data line. After receiving each read operation data byte, the I2C master controller 100a drives the I2C data line to generate an acknowledgment bit, which can be I2C ACK (I2C data line level low) or I2C NAK (I2C data line has a high level).

According to the standard I2C specification, when the I2C master controller 100a sends the read address byte and the I2C interface module 200a returns the read operation data bytes, the I2C master controller 100a drives the I2C data line to send the number of bits contained in the read address byte, while the I2C interface module 200a drives the I2C data line to return the bits contained in the read operation data bytes. For each bit in the read address byte and read operation data bytes, the I2C master controller 100a drives the I2C clock line to generate a clock pulse.

According to the standard I2C specification, for the acknowledge bit corresponding to the read address byte and the acknowledge bit of the read operation data byte, the I2C master controller 100a also drives the I2C clock line to generate a clock pulse. The I2C master controller 100a terminates the current read operation by sending the I2C STOP signal (P) or I2C START signal(S) defined by the standard I2C specification.

An I2C write operation or I2C read operation cycle begins with the I2C START signal (S), but there are two ways to end it. The first is to end with the I2C STOP signal (P), as shown in the timing diagrams of FIGS. 4 and 5.

The second method is to generate a new I2C START signal(S), initiating the next I2C write operation or I2C read operation, as shown in the timing diagram of FIG. 6. In FIG. 6, the dashed line between the acknowledge bit (A/N) and the I2C START signal (Sr) (and similar lines in other figures) is due to the lengthy timing diagram being split across a plurality of lines for clarity, indicating a sequential connection between the two timing diagrams.

Using either of the above termination methods does not affect the data writing method of the present disclosure. For convenience of description, this embodiment describes the end of an I2C operation (I2C write operation or I2C read operation) using the method with the I2C STOP signal (P).

The write command packet of the present disclosure is transmitted through the write operation data bytes (BYTE(1), . . . , BYTE(N), shaded). As shown in FIG. 2, four embodiments of write command packets are provided:
The write command packet may only include write command 1, write command 2, . . . , write command N.

The write command packet may also include a write command packet length field and write command 1, write command 2, . . . , write command N.

The write command packet may also include a remote I2C address and write command 1, write command 2, . . . , write command N.

The write command packet may also include a write command packet length field, a remote I2C address, and write command 1, write command 2, . . . , write command N.

It should be noted that the present disclosure does not limit the format of the write command packet. That is, the write command packet format in the present disclosure is not limited to the four embodiments shown in FIG. 2. The I2C master controller 100a and the I2C interface module 200a may agree on other write command packet formats.

The write command packet of the present disclosure is used to distinguish read command packets. The write command packet is used to implement data writing to the remote I2C slave device 400, while the read command packet is used to read data from the remote I2C slave device 400. The present disclosure does not limit the method of reading data from the remote I2C slave device 400 via read command packets.

For example, when the I2C master controller 100a initiates a write command packet, it initiates an I2C write operation to send the write address byte and the write operation data bytes (BYTE(1), . . . , BYTE(N), shaded) containing the write command packet to the I2C interface module 200a.

The I2C interface module 200a comprises a logic circuit with an I2C interface, which receives and responds to data from the I2C master controller 100a. The I2C interface module 200a and the I2C master controller 100a are interconnected via an I2C bus (I2C clock line and I2C data line). One I2C master controller 100a can connect to one or more I2C interface modules 200a, each of which has a unique I2C address (ADDR) on its respective I2C bus (I2C clock line and I2C data line). According to the standard I2C specification, every I2C write operation or I2C read operation, except for I2C write broadcasts, targets only one I2C address (ADDR). I2C interface modules 200a with other I2C addresses do not participate in that I2C write operation or I2C read operation.

As shown in FIG. 7, in a specific embodiment, the I2C interface module 200a has a 7-bit I2C address of 0x50 (corresponding to the write address byte 0xA0 or binary value 1010000). The 2C master controller 100a initiates an I2C write operation, sequentially writing 0x06, 0x11, 0x21, 0x31, 0x41, 0x51 and 0x61—totaling 7 bytes of write operation data—into the I2C interface module 200a. These 7 bytes of write operation data include the write command packet. The 0xA0 byte corresponds to the write address byte, where the upper 7 bits represent the I2C address (ADDR) of the I2C interface module 200a, and the least significant bit (LSB) is the write operation indicator (W). A value of 0 for the write operation indicator (W) signifies a write operation, making the byte value 10100000 in binary, or 0xA0 in hexadecimal.

In this example, the write command packet format can be one of the four embodiments shown in FIG. 2 or another format agreed upon between the I2C master controller 100a and the I2C interface module 200a.

In the present disclosure, the I2C interface module 200a receiving the write command packet means that the write operation data received by the I2C interface module 200a contains a complete write command packet. As illustrated in the embodiment of FIG. 7, the 7-byte write operation data (0x06, 0x11, 0x21, 0x31, 0x41, 0x51, 0x61) includes a complete write command packet. Therefore, when the I2C interface module 200a receives the last bit of the 0x61 byte, it has received the write command packet.

As shown in FIG. 2, the write command packet may include a write command packet length field. The I2C interface module 200a can determine whether the received write operation data contains a complete write command packet based on the agreement with the I2C master controller 100a (either fully or partially relying on the write command packet length field). Alternatively, as shown in FIG. 2, the write command packet may not include a write command packet length field. In this case, the I2C interface module 200a can determine whether the received write operation data contains a complete write command packet based on the agreement with the I2C master controller 100a (where this agreement does not rely on the write command packet length field).

In the embodiment shown in FIG. 7, the I2C interface module 200a receives the last bit of the 0x61 byte, the I2C interface module 200a receives the write command packet, and then the I2C interface module 200a pulls the clock line level low. The I2C bus enters a HOLD state (sustained low-level state), and the I2C interface module 200a sends the write command packet to the functional module 300. The functional module 300 receives the write command packet and executes the plurality of write commands contained in it, namely write command 1, write command 2, . . . , write command N, and then returns a write status packet to the I2C interface module 200a, including:
when the execution result of each write command in the write command packet is success, the functional module 300 returning a write status packet with successful status information to the I2C interface module 200a;
when the execution result of at least one write command in the write command packet is failure, the functional module 300 returning a write status packet with status information indicating failure to the I2C interface module 200a.

In the present disclosure, when the I2C interface module 200a sends the write command packet to the functional module 300, it may modify, add, or delete the content of the write command packet, which is neither restricted nor specified by the present disclosure.

According to an embodiment of the present disclosure, when the I2C interface module 200a receives the write status packet and the status information indicates success, the I2C interface module 200a stops pulling the I2C clock line low and returns an I2C ACK to the I2C master controller 100a.

When the I2C interface module 200a receives the write status packet and the status information indicates failure, the I2C interface module 200a stops pulling the I2C clock line low and returns an I2C NAK to the I2C master controller 100a.

The subsequent I2C operation referred to in the present disclosure is relative to the preceding I2C operation, and the I2C operation may be an I2C write operation or an I2C read operation.

As shown in FIG. 8, an example is given to describe the scenario when the I2C interface module 200a receives the write status packet and the status information indicates success. The I2C master controller 100a initiates an I2C operation (I2C write operation) with a sequence number m (where m is a natural number), and the I2C operation with a sequence number m+1 initiated by the I2C master controller 100a is a subsequent I2C operation (relative to the I2C operation with a sequence number m).

In the embodiment shown in FIG. 8, the write command packet is sent via the I2C write operation with a sequence number m. The I2C interface module 200a pulls the I2C clock line low after receiving the write command packet (after receiving BYTE(N)).

At moment \textcircled{1}, the I2C interface module 200a receives the write status packet with status information indicating success. The I2C interface module 20a stops pulling the I2C clock line low, terminating the HOLD state (ending the sustained low-level state).

At moment \textcircled{2}, the I2C interface module 200a returns an I2C ACK to the I2C master controller 100a. The I2C master controller 100a terminates the I2C operation (I2C write operation) with a sequence number m and initiates the I2C operation with a sequence number m+1 (subsequent I2C operation), which may be an I2C write operation or an I2C read operation.

After the I2C interface module 200a returns an I2C ACK in the I2C operation numbered m, it continues to receive subsequent I2C operations initiated by the I2C master controller 100a (referring to returning an I2C ACK after receiving the read address byte or write address byte in the I2C operation numbered m+1 and continuing the I2C operation numbered m+1). This process repeats, and the I2C master controller 100a continuously initiates I2C operations.

As shown in FIG. 9, an example is given to describe the scenario when the I2C interface module 200a receives a write status packet and the status information of the write status packet indicates failure. The I2C master controller 100a initiates an I2C operation (I2C write operation) numbered m (where m is a natural number). The I2C master controller 100a sends a write command packet through the I2C write operation numbered m. After receiving the write command packet (upon receiving BYTE(N)), the I2C interface module 200a pulls the I2C clock line level low.

At moment \textcircled{1}, the I2C interface module 200a receives the write status packet, and the status information of the write status packet indicates failure. The I2C interface module 200a stops pulling the I2C clock line level low and terminates the HOLD state (ending the sustained low-level state).

At moment \textcircled{2}, the I2C interface module 200a returns an I2C NAK to the I2C master controller 100a. The I2C master controller 100a terminates the I2C operation (I2C write operation) numbered m.

After the I2C interface module 200a returns an I2C NAK in the I2C operation numbered m, if the I2C master controller 100a initiates a subsequent I2C operation and the subsequent I2C operation is an I2C write operation, the I2C interface module 200a, upon receiving the write address byte, returns an I2C NAK to the I2C master controller 100a, thereby terminating the execution of the subsequent I2C operation (I2C write operation).

After the I2C interface module 200a returns an I2C NAK in the I2C operation with a sequence number m, if the I2C master controller 100a initiates a subsequent I2C operation and the subsequent I2C operation is an I2C read operation, the I2C interface module 200a, upon receiving the read address byte, returns an I2C ACK to the I2C master controller 100a and continues to return the status information (STATUS) of the write status packet, thereby enabling the I2C master controller 100a to proceed with the subsequent I2C operation (I2C read operation). During the I2C master controller 100a's execution of the subsequent I2C operation (I2C read operation), it reads the status information (STATUS) of the write status packet. After completing the subsequent I2C operation (I2C read operation), the I2C interface module 200a continues to receive the next I2C operation initiated by the I2C master controller 100a, repeating the above process, where the I2C master controller 100a continuously initiates I2C operations. In the present disclosure, the status information (STATUS) may include success or failure information contained in the write status packet, as well as other information. According to an embodiment of the present disclosure, the I2C master controller 100a is connected to the I2C interface module 200a via the I2C clock line and I2C data line. The I2C master controller 100a initiates an I2C write operation to send the write command packet to the I2C interface module 200a, which then forwards the write command packet to the functional module 300.

The functional module 300 receives the write command packet and executes the plurality of write commands contained within, namely write command 1, write command 2, . . . , write command N, and then returns a write status packet to the I2C interface module 200a, including:
when the execution result of every write command in the write command packet is success, the functional module 300 returning a write status packet with status information indicating success to the I2C interface module 200a;
when the execution result of at least one write command in the write command packet is a failure, the functional module 300 returning a write status packet with status information indicating failure to the I2C interface module 200a.

In the present disclosure, when the I2C interface module 200a sends the write command packet to the functional module 300, it may modify, add, or delete the contents of the write command packet, and the present disclosure does not impose any restrictions or regulations on this.

The functional module 300 returns the write status packet to the I2C interface module 200a, which then returns the status information of the write status packet to the I2C master controller 100a, including:
after the I2C interface module 200a receives the write command packet,
if the subsequent operation initiated by I2C the master controller 100a is a write operation, and the I2C interface module 200a receives the write status packet returned by the functional module 300 to the I2C interface module 200a with the status information indicating success, then the I2C interface module 200a accepting the subsequent I2C write operation initiated by the I2C master controller 100a;
if the subsequent operation initiated by the I2C master controller 100a is a write operation, and the I2C interface module 200a receives the write status packet returned by the functional module 300 to the I2C interface module 200a with the status information indicating failure, then the I2C interface module 200a returning an I2C NAK to the I2C master controller 100a.

If the subsequent operation initiated by the I2C master controller 100a is a read operation, and the I2C interface module 200a receives the write status packet returned by the functional module 300 to the I2C interface module 200a, then the I2C interface module 200a returns the status information of the write status packet to the I2C master controller 100a.

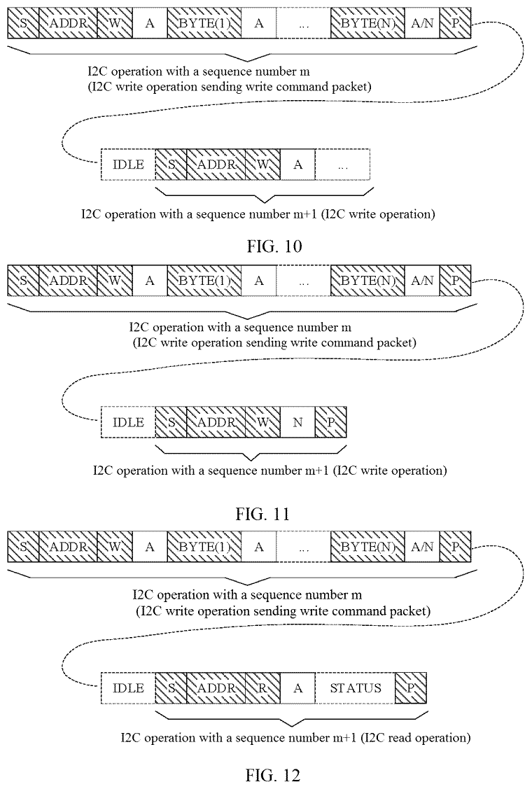

As shown in FIGS. 10 and 11, the I2C operation with a sequence number m initiated by the I2C master controller 100a is an I2C write operation that sends the write command packet to the I2C interface module 200a. For the first N-1 write operation data bytes (BYTE(1), . . . , BYTE(N−1)), after each write operation data byte is sent, the I2C interface module 200a returns an I2C ACK to the I2C master controller 100a.

After the interface module 200a receives the Nth write operation data byte (BYTE(N)) (i.e., after the I2C interface module 200a receives the complete write command packet), the I2C interface module 200a may return an I2C ACK or I2C NAK to the I2C master controller 100a, determined by the agreement between the I2C master controller 100a and the I2C interface module 200a. The agreement may specify that regardless of whether an I2C ACK or I2C NAK is returned after the Nth write operation data byte (BYTE(N)), it indicates successful reception of the Nth write operation data byte (i.e., the complete write command packet). Alternatively, the agreement may specify that an I2C NAK indicates the Nth write operation data byte (BYTE(N)) was not successfully received (i.e., the complete write command packet was not successfully received). In the following description of the present disclosure, regardless of whether the I2C interface module 200a returns an I2C ACK or I2C NAK to the I2C master controller 100a after the Nth write operation data byte (BYTE(N)), it signifies successful reception of the Nth write operation data byte (i.e., the complete write command packet).

After the I2C master controller 100a completes sending the Nth write operation data byte (BYTE(N)), regardless of whether the I2C interface module 200a returns an I2C ACK or I2C NAK to the I2C master controller 100a, the I2C master controller 100a terminates the m th I2C operation (I2C write operation) and may optionally initiate the m+1 th I2C operation (subsequent I2C operation).

When the I2C operation numbered m+1 (subsequent I2C operation) is an I2C write operation, if the I2C interface module 200a receives the write status packet returned by the functional module 300 to the I2C interface module 200a (the write status packet corresponding to the I2C operation numbered m) and the status information in the write status packet indicates success, then after the I2C master controller 100a sends the write address byte, the I2C interface module 200a returns an I2C ACK to the I2C master controller 100a. The I2C interface module 200a then receives the write operation data bytes sent by the I2C master controller 100a for the I2C operation numbered m+1 (subsequent I2C operation/I2C write operation), as shown in FIG. 10.

If the I2C interface module 200a receives a write status packet (the write status packet corresponding to the I2C operation with a sequence number m) returned by the functional module 300 to the I2C interface module 200a, and the status information of the write status packet indicates failure, then after the I2C master controller 100a sends the write address byte, the I2C interface module 200a returns an I2C NAK to the I2C master controller 100a, and the master controller 100a terminates the initiation of the m+1 I2C operation (subsequent I2C operation/I2C write operation), as shown in FIG. 11.

As shown in FIG. 12, the I2C operation with a sequence number m initiated by the I2C master controller 100a is an I2C write operation that sends a write command packet to the I2C interface module 200a. For the first N−1 write operation data bytes (BYTE(1), . . . , BYTE(N−1)), after each write operation data byte is sent, the I2C interface module 200a returns I2C ACK to the I2C master controller 100a.

After the I2C interface module 200a receives the Nth write operation data byte (BYTE(N)) (i.e., after the I2C interface module 200a receives the complete write command packet), the I2C interface module 200a may return I2C ACK or I2C NAK to the I2C master controller 100a.

After the I2C master controller 100a completes sending the Nth write operation data byte (BYTE(N)), regardless of whether the I2C interface module 200a returns an I2C ACK or I2C NAK to the I2C master controller 100a, the I2C master controller 100a terminates the I2C operation (the I2C write operation) with a sequence number m and may optionally initiate the I2C operation (subsequent I2C operation) with a sequence number m+1.

When the I2C operation (subsequent I2C operation) with a sequence number m+1 is an I2C read operation, if the I2C interface module 200a receives a write status packet (the status packet corresponding to the I2C operation with a sequence number m) returned by the functional module 300 to the I2C interface module 200a, then after the I2C master controller 100a sends the read address byte, the I2C interface module 200a returns an I2C ACK to the I2C master controller 100a and returns the status information (STATUS) of the write status packet (the status packet corresponding to the I2C operation with a sequence number m) . In the present disclosure, the status information (STATUS) may include the success or failure information contained in the write status packet, or other information included in the write status packet.

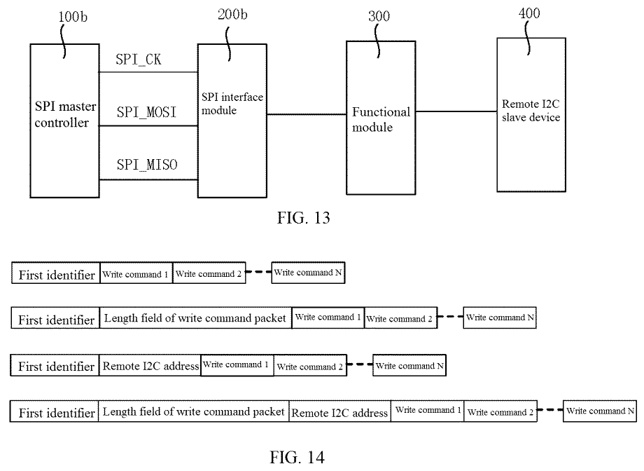

As shown in FIG. 13, in one embodiment, the master controller 100 is an SPI master controller 100b, the interface module 200 is an SPI interface module 200b, and the SPI master controller 100b is connected to the SPI interface module 200b via the SPI_CK signal line, SPI_MOSI signal line, and SPI_MISO signal line.

The SPI master controller 100b generates a clock edge on the SPI_CK signal line and transmits a write command packet to the SPI interface module 200b via the SPI_MOSI signal line. The write command packet begins with a first identifier, and the SPI interface module 200b forwards the write command packet to the functional module 300 upon receiving it from SPI_MOSI.

The functional module 300 receives the write command packet and executes the plurality of write commands contained within it, namely write command 1, write command 2, . . . , write command N, then returns a write status packet to the SPI interface module 200b, including:
when the execution result of every write command in the write command packet is success, the functional module 300 returning a write status packet with a status indicating success to the SPI interface module 200b;
when the execution result of at least one write command in the write command packet is a failure, the functional module 300 returning a write status packet with a status indicating failure to the SPI interface module 200b.

In the present disclosure, when the SPI interface module 200b sends the write command packet to the functional module 300, it may modify, add, or delete the contents of the write command packet, and the present disclosure imposes no restrictions or regulations on this.

The functional module 300 returns the write status packet to the SPI interface module 200b, which then relays the status information of the write status packet back to the SPI master controller 100b, including:
upon receiving the write status packet, when the SPI master controller 100b generates a clock edge on SPI_CK, the SPI interface module 200b sending a write feedback packet to the SPI master controller 100b via the SPI_MISO signal line, where the write feedback packet begins with a second identifier and contains the status information from the write status packet.

As shown in the embodiment of FIG. 14, when the master controller 100 is the SPI master controller 100b and the interface module 200 is the SPI interface module 200b, the data structure of the write command packet is illustrated. The embodiment exemplarily presents four types of write command packets:
The write command packet may include the first identifier and write command 1, write command 2, . . . , write command N, starting with the first identifier.

The write command packet may also include the first identifier, a write command packet length field, and write command 1, write command 2, . . . , write command N, starting with the first identifier.

The write command packet may also include the first identifier, a remote I2C address, write command 1, write command 2, . . . , write command N, starting with the first identifier.

The write command packet may also include the first identifier, a write command packet length field, a remote I2C address, write command 1, write command 2, . . . , write command N, starting with the first identifier.

The first identifier included in the write command packet, the write command packet length field (if present), the remote I2C address (if present), write command 1, write command 2, . . . , write command N are composed of binary bit sequences. The present disclosure does not limit the lengths of the binary bit sequences for the first identifier, the write command packet length field (if present), the remote I2C address (if present), write command 1, write command 2, . . . , write command N.

It should be noted that the present disclosure does not limit the format of the write command packet, meaning the write command packet format in the present disclosure is not limited to the four write command packet embodiments shown in FIG. 14. The SPI master controller 100b and the SPI interface module 200b may agree on other write command packet formats.

In the present disclosure, the SPI interface module 200b receiving the write command packet means that the data received by the SPI interface module 200b from the SPI_MOSI signal line contains a complete write command packet. As shown in FIG. 14, the write command packet may include a write command packet length field. The SPI interface module 200b can determine whether the received data contains a complete write command packet based on the agreement with the SPI master controller 100b, either fully or partially relying on the write command packet length field. As shown in FIG. 14, the write command packet may also exclude the write command packet length field. In such cases, the SPI interface module 200b determines whether the received data contains a complete write command packet based on the agreement with the SPI master controller 100b (where this agreement does not rely on the write command packet length field).

The SPI master controller 100b drives the SPI_CK signal line, generating clock edges on it. The SPI master controller 100b samples data on the SPI_MISO signal line at the rising or falling clock edges of the SPI_CK signal line. The SPI interface module 200b samples data on the SPI_MOSI signal line at the rising or falling clock edges of the SPI_CK signal line, enabling bidirectional data transmission between the SPI master controller 100b and the SPI interface module 200b.

The present disclosure does not limit whether data on the SPI_MISO and SPI_MOSI signal lines is sampled at the rising or falling clock edges of the SPI_CK signal line. In the embodiments described below, data on the SPI_MISO and SPI_MOSI signal lines is sampled at the rising clock edges of the SPI_CK signal line, meaning the rising clock edges of the SPI_CK signal line serve as the sampling clock edges in these embodiments. In other embodiments of the present disclosure, data on the SPI_MISO and SPI_MOSI signal lines may also be sampled at the falling clock edges of the SPI_CK signal line, meaning the falling clock edges of the SPI_CK signal line serve as the sampling clock edges in those embodiments.

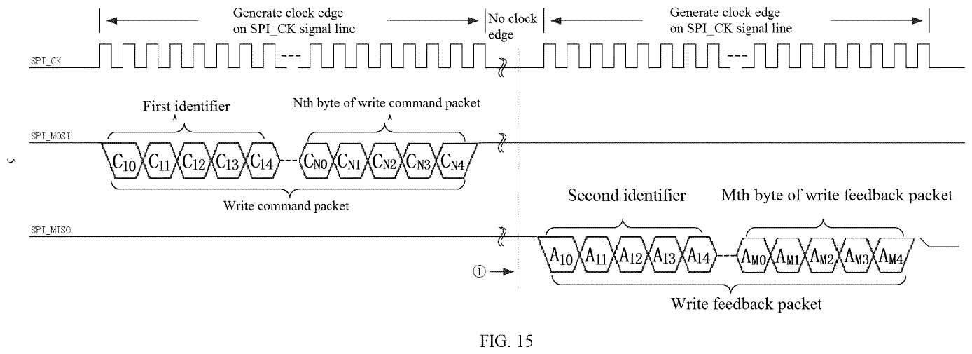

As shown in FIG. 15, the SPI master controller 100b generates a clock edge on the SPI_CK signal line while driving the SPI_MOSI signal line to transmit the write command packet to the SPI interface module 200b via the SPI_MOSI signal line. The write command packet contains N bytes, each being 8-bit binary data. The first byte is the first identifier, with its 8-bit binary data represented as C₁₀, C₁₁ . . . C₁₇. The Nth byte of the write command packet is its last byte, and its 8-bit binary data is denoted by C_{N0}, C_{N1} . . . C_{N7}.

The SPI interface module 200b samples the data on the SPI_MOSI signal line at the rising clock edge of the SPI_CK signal line, receiving the write command packet from the SPI_MOSI signal line. When the SPI interface module 200b samples C_{N7} bits, the data received from the SPI_MOSI signal line contains the complete write command packet, and the SPI interface module 200b successfully receives it.

After receiving the write command packet from the SPI_MOSI signal line, the SPI interface module 200b sends it to the functional module 300. In the present disclosure, the SPI interface module 200b may modify, add, or delete content in the write command packet when transmitting it to the functional module 300, as the present disclosure imposes no restrictions or regulations on this.

The functional module 300 receives the write command packet and executes the plurality of write commands it contains, namely write command 1, write command 2, . . . , write command N. It then returns a write status packet to the SPI interface module 200b, including:
When the execution result of every write command in the write command packet is success, the functional module 300 returns a write status packet with a success status to the SPI interface module 200b.

When at least one write command in the write command packet fails to execute, the functional module 300 returns a write status packet with a failure status to the SPI interface module 200b.

At moment \textcircled{1}, the SPI interface module 200b receives the write status packet. The SPI master controller 100b generates a clock edge on the SPI_CK signal line, and the SPI interface module 200b drives the SPI_MISO signal line to transmit the write feedback packet via the SPI_MISO signal line. The SPI master controller 100b samples the data on the SPI_MISO signal line at the rising clock edge of the SPI_CK signal line to read the write feedback packet. The write feedback packet starts with the second identifier and contains the status information from the write status packet. This status information may indicate write success or write failure, or other status details.

The write feedback packet contains M bytes, each byte being 8-bit binary data. The first byte is the second identifier, with its 8-bit binary data represented as A₁₀, A₁₁ . . . A₁₇. The Mth byte of the write feedback packet is its last byte, and the 8-bit binary data of the M-th byte is represented as A_{M0}, A_{M1} . . . A_{M7}.

For clarity, in the embodiment shown in FIG. 15 and the following descriptions of the present disclosure, each byte is described as 8-bit binary data. However, the present disclosure does not limit the number of bits per byte, and each byte may also have other bit counts.

In the embodiment shown in FIG. 15, the length of the first and second identifiers is one byte, and the lengths of the write command packet and write feedback packet are integer multiples of bytes. For clarity, in the following descriptions of the present disclosure, the lengths of the first to fourth identifiers are one byte, and the lengths of the write command packet and write feedback packet (including the write success feedback packet and write failure feedback packet) are integer multiples of bytes. However, the present disclosure does not restrict the lengths of the first to fourth identifiers to one byte, nor does it require their lengths to be integer multiples of bytes. Similarly, the present disclosure does not limit the lengths of the write command packet and write feedback packet (including the write success feedback packet and write failure feedback packet) to integer multiples of bytes.

In intervals labeled “no clock edge,” the SPI master controller 100b does not generate sampling clock edges on the SPI_CK signal line. In FIG. 15 and subsequent embodiments of the present disclosure, the levels on the SPI_MOSI and SPI_MISO signal lines remain unchanged during “no clock edge” intervals. However, the present disclosure does not restrict the levels on the SPI_MOSI and SPI_MISO signal lines during these intervals; they may also change. Nonetheless, since data sampling on the SPI_MOSI and SPI_MISO signal lines occurs only at the sampling clock edges on the SPI_CK signal line (in the embodiment of FIG. 15, the sampling clock edge is the rising edge), level changes on the SPI_MOSI and SPI_MISO signal lines during “no clock edge” intervals will not be sampled or received.

In the embodiment shown in FIG. 15, the SPI master controller 100b generates a clock edge on the SPI_CK signal line while driving the SPI_MOSI signal line. When sending a write command packet via the SPI_MOSI signal line, the SPI interface module 200b has no write feedback packet to transmit. At this time, the SPI interface module 200b drives the SPI_MISO signal line to a high level. During this period, the SPI interface module 200b of the present disclosure may also drive the SPI_MISO signal line to a low level or a varying level. However, the SPI interface module 200b must ensure that the level value or varying level value it drives on the SPI_MISO signal line, if sampled by the SPI master controller 100b at the sampling clock edge on the SPI_CK signal line (the sampling clock edge in the embodiment of FIG. 15 is the rising clock edge), is not recognized as the second identifier. Taking the embodiment in FIG. 15 as an example, since the SPI interface module 200b drives the SPI_MISO signal line to a high level during this period (sampled as consecutive binary bits 1), to avoid being recognized as the second identifier, the value of the second identifier should not be 0xFF.

In the embodiment shown in FIG. 15, the SPI master controller 100b generates a clock edge on the SPI_CK signal line, and the SPI interface module 200b drives the SPI_MISO signal line. When sending a write feedback packet via the SPI_MISO signal line, the SPI master controller 100b has no write command packet to transmit. At this time, the SPI master controller 100b drives the SPI_MOSI signal line to a high level. During this period, the SPI master controller 100b of the present disclosure may also drive the SPI_MOSI signal line to a low level or a varying level. However, the SPI master controller 100b must ensure that the level value or varying level value it drives on the SPI_MOSI signal line, if sampled by the SPI interface module 200b at the sampling clock edge on the SPI_CK signal line (the sampling clock edge in the embodiment of FIG. 15 is the rising clock edge), is not recognized as the first identifier. Taking the embodiment in FIG. 15 as an example, since the SPI master controller 100b drives the SPI_MOSI signal line to a high level during this period (sampled as consecutive binary bits 1), to avoid being recognized as the first identifier, the value of the first identifier should not be 0xFF.

The SPI interface module 200b can connect to the SPI master controller 100b not only through the SPI_CK signal line, SPI_MOSI signal line, and SPI_MISO signal line but also via the SPI_CSN signal line. The SPI master controller 100b drives the SPI_CSN signal line, SPI_CK signal line, and SPI_MOSI signal line, while the SPI interface module 200b receives these signals. Conversely, the SPI interface module 200b drives the SPI_MISO signal line, and the SPI master controller 100b receives it. The SPI_CSN signal line serves as a selection signal; in the SPI protocol, data transmission occurs only when the SPI_CSN signal line is low. One SPI master controller 100b can connect to a plurality of SPI interface modules 200b, sharing the SPI_CK, SPI_MOSI, and SPI_MISO signal lines among them. However, each SPI interface module 200b has an independent SPI_CSN signal line input. When the SPI_CSN signal line of an SPI interface module 200b is high, that module does not drive the SPI_MISO signal line (its driver output connected to the SPI_MISO signal line enters a Hi-Z state). An SPI interface module 200b drives the SPI_MISO signal line only when its SPI_CSN signal line is low. When one SPI master controller 100b is connected to a plurality of SPI interface modules 200b, only one module's SPI_CSN signal line is low at any given time, preventing conflicts caused by a plurality of modules simultaneously driving the SPI_MISO signal line.

When an SPI master controller 100b is connected to only one SPI interface module 200b, that module can drive the SPI_MISO signal line at any time without causing conflicts. In this scenario, the SPI master controller 100b and the SPI interface module 200b may omit the SPI_CSN signal line. That is, when an SPI master controller 100b is connected to only one SPI interface module 200b, they can be linked solely through the SPI_CK, SPI_MOSI, and SPI_MISO signal lines. The description of the embodiment shown in FIG. 15 corresponds to this case.

The present disclosure describes only the scenario where no SPI_CSN signal line exists between the SPI master controller 100b and the SPI interface module 200b. However, based on the description herein, it is straightforward to extend this to cases where an SPI_CSN signal line is present. The present disclosure does not reiterate the latter scenario. Whether or not an SPI_CSN signal line exists between the SPI master controller 100b and the SPI interface module 200b, both cases fall within the scope of protection of the present disclosure.

According to an embodiment of the present disclosure, the SPI master controller 100b generates a clock edge on the SPI_CK signal line and reads the write feedback packet via the SPI_MISO signal line.

When the SPI interface module 200b does not receive the write status packet, the SPI interface module 200b sends data that cannot be recognized as a write feedback packet to the SPI master controller 100b via the SPI_MISO signal line.

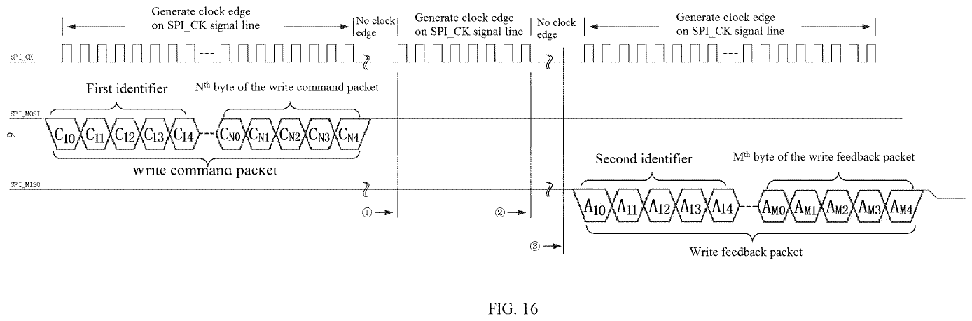

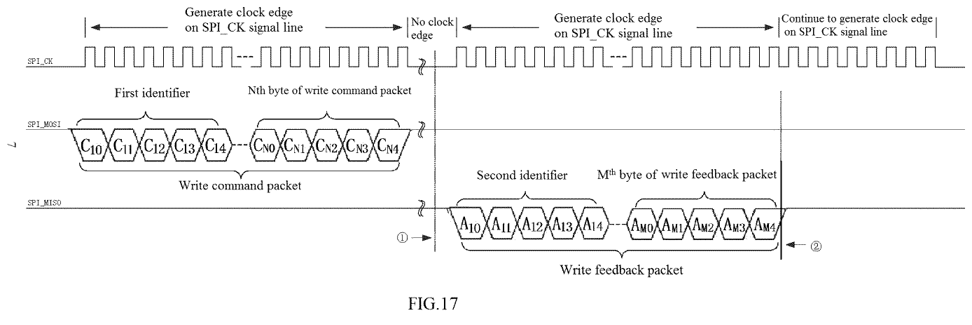

Taking FIG. 16 as an example, the SPI master controller 100b generates a clock edge on the SPI_CK signal line and sends the write command packet to the SPI interface module 200b via the SPI_MOSI signal line. After receiving the write command packet from the SPI_MOSI signal line, the SPI interface module 200b sends the write command packet to the functional module 300. The functional module 300 receives the write command packet and executes the plurality of write commands contained in it, then returns a write status packet to the SPI interface module 200b. At moment \textcircled{3}, the SPI interface module 200b receives the write status packet. Before moment \textcircled{3} when the SPI interface module 200b receives the write status packet, between moment \textcircled{1} and moment \textcircled{2}, the SPI master controller 100b generates a clock edge on the SPI_CK signal line. In the embodiment shown in FIG. 16, the SPI interface module 200b drives the SPI_MISO signal line to a high level. During this period, the SPI interface module 200b may also drive the SPI_MISO signal line to a low level or a changing level.

However, the SPI interface module 200b must ensure that the level value or changing level value it drives on the SPI_MISO signal line, if sampled by the sampling clock edge (in the embodiment of FIG. 16, the sampling clock edge is the rising edge) generated by the SPI master controller 100b on the SPI_CK signal line, is not recognized as the second identifier. That is, when the SPI interface module 200b has not received the write status packet, if the SPI master controller 100b generates a clock edge on the SPI_CK signal line, the SPI interface module 200b sends data that cannot be recognized as a write feedback packet to the SPI master controller 100b via the SPI_MISO signal line. After the SPI interface module 200b receives the write status packet at moment \textcircled{3}, the SPI master controller 100b generates a clock edge on the SPI_CK signal line and reads the write feedback packet from the SPI interface module 200b via the SPI_MISO signal line.

In the embodiment shown in FIG. 17, the SPI master controller 100b generates a clock edge on the SPI_CK signal line and transmits the write command packet to the SPI interface module 200b via the SPI_MOSI signal line. Upon receiving the write command packet from the SPI_MOSI signal line, the SPI interface module 200b sends the write command packet to the functional module 300. The functional module 300 receives the write command packet and executes the plurality of write commands contained within it, then returns a write status packet to the SPI interface module 200b. At moment \textcircled{1}, the SPI interface module 200b receives the write status packet, and the SPI master controller 100b generates a clock edge on the SPI_CK signal line and reads the write feedback packet from the SPI interface module 200b via the SPI_MISO signal line. At moment \textcircled{2}, the SPI master controller 100b completes reading the write feedback packet, and the SPI interface module 200b finishes transmitting the write feedback packet. The SPI master controller 100b continues to generate clock edges on the SPI_CK signal line, during which the SPI interface module 200b drives the SPI_MISO signal line to a high level. Alternatively, the SPI interface module 200b may drive the SPI_MISO signal line to a low level or a varying level during this period. However, the SPI interface module 200b must ensure that the level or varying level it drives on the SPI_MISO signal line, if sampled by the SPI master controller 100b at the sampling clock edge on the SPI_CK signal line (in this embodiment, the sampling clock edge is the rising edge), is not recognized as the second identifier.

According to an embodiment of the present disclosure, the SPI master controller 100b generates a clock edge on the SPI_CK signal line and transmits the write command packet to the SPI interface module 200b via the SPI_MOSI signal line.

Subsequently, the SPI master controller 100b generates a clock edge on the SPI_CK signal line and reads the write feedback packet via the SPI_MISO signal line. After the SPI interface module 200b transmits the write feedback packet through the SPI_MISO signal line, it can continue to receive subsequent command packets (which include write command packets and read command packets).

In the present disclosure, the SPI master controller 100b generates a clock edge on the SPI_CK signal line and transmits the write command packet to the SPI interface module 200b via the SPI_MOSI signal line. Upon receiving the write command packet from the SPI_MOSI signal line, the SPI interface module 200b forwards it to the functional module 300. The functional module 300 receives the write command packet, executes the plurality of write commands contained within it, and then returns a write status packet to the SPI interface module 200b. Subsequently, the SPI master controller 100b generates a clock edge on the SPI_CK signal line and reads the write feedback packet via the SPI_MISO signal line. Before the SPI master controller 100b reads the write feedback packet, if it drives the SPI_MOSI signal line to send a command packet (including write command packets or read command packets), the SPI interface module 200b will not accept any command packets sent prior to the read operation of the write feedback packet. After the SPI master controller 100b reads the write feedback packet—that is, after the SPI interface module 200b transmits the write feedback packet via the SPI_MISO signal line—the SPI interface module 200b can continue to receive subsequent command packets (which include write command packets and read command packets).

According to an embodiment of the present disclosure, the write feedback packet is categorized into a write success feedback packet and a write failure feedback packet.

The SPI master controller 100b generates a clock edge on the SPI_CK signal line and reads the write feedback packet via the SPI_MISO signal line.

When the SPI interface module 200b receives the write status packet and the status information contained in the write status packet indicates success, the SPI interface module 200b transmits a write success feedback packet via the SPI_MISO signal line, starting with a third identifier.

When the SPI interface module 200b receives the write status packet and the status information contained in the write status packet indicates failure, the SPI interface module 200b transmits a write failure feedback packet via the SPI_MISO signal line, starting with a fourth identifier.

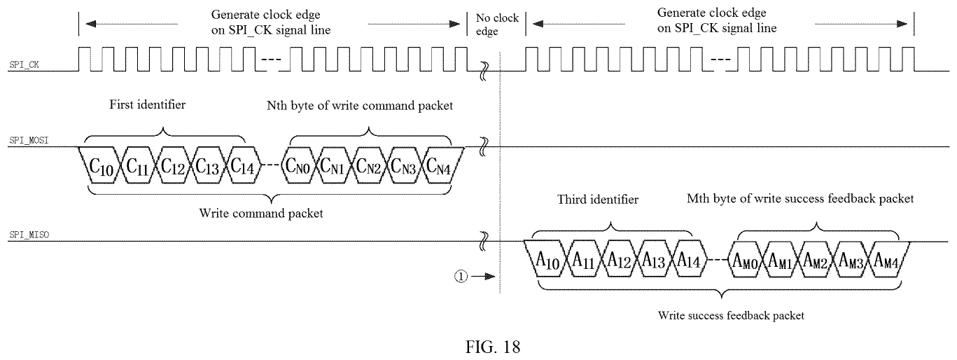

As shown in FIG. 18, the SPI master controller 100b generates a clock edge on the SPI_CK signal line and transmits the write command packet to the SPI interface module 200b via the SPI_MOSI signal line. After receiving the write command packet from the SPI_MOSI signal line, the SPI interface module 200b forwards it to the functional module 300.

The functional module 300 receives the write command packet, executes the plurality of write commands contained within it, and then returns a write status packet to the SPI interface module 200b. At moment \textcircled{1}, the SPI interface module 200b receives the write status packet, and the status information contained in the write status packet indicates success. When the SPI master controller 100b generates a clock edge on the SPI_CK signal line and reads the write feedback packet from the SPI interface module 200b via the SPI_MISO signal line, the SPI interface module 200b drives the SPI_MISO signal line to transmit the write success feedback packet to the SPI master controller 100b, starting with a third identifier.

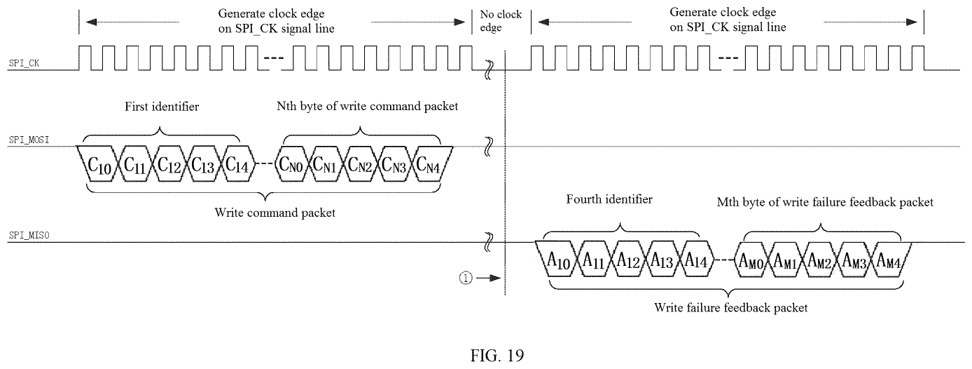

As shown in FIG. 19, the SPI master controller 100b generates a clock edge on the SPI_CK signal line and transmits the write command packet to the SPI interface module 200b via the SPI_MOSI signal line. After receiving the write command packet from the SPI_MOSI signal line, the SPI interface module 200b sends the write command packet to the functional module 300. The functional module 300 receives the write command packet and executes the plurality of write commands contained within it, then returns a write status packet to the SPI interface module 200b. At moment \textcircled{1}, the SPI interface module 200b receives the write status packet, which contains status information indicating failure. When the SPI master controller 100b generates a clock edge on the SPI_CK signal line and reads the write feedback packet from the SPI interface module 200b via the SPI_MISO signal line, the SPI interface module 200b drives the SPI_MISO signal line to send a write failure feedback packet to the SPI master controller 100b. The write failure feedback packet begins with a fourth identifier.

In the present disclosure, the third identifier differs from the fourth identifier. When the SPI master controller 100b reads the write feedback packet, it can determine whether the received packet is a write success feedback packet or a write failure feedback packet based on whether the packet starts with the third identifier or the fourth identifier. Therefore, the write success feedback packet may only contain the third identifier, and the write failure feedback packet may only contain the fourth identifier, enabling the SPI master controller 100b to distinguish between the two types of feedback packets.

In the present disclosure, the master controller 100 can not only be the I2C master controller 100a or the SPI master controller 100b but also a master controller compliant with other interface protocols (e.g., UART, CAN, LIN, etc.). Similarly, the interface module 200 in the present disclosure can not only be the I2C interface module 200a or the SPI interface module 200b but also an interface module compliant with other interface protocols (e.g., UART, CAN, LIN, etc.). The use of master controllers and interface modules conforming to other interface protocols also falls within the scope of protection of the present disclosure.

According to an embodiment of the present disclosure, the master controller 100 (I2C master controller 100a, SPI master controller 100b, or a master controller compliant with other interface protocols) sends a write command packet to the interface module 200 (I2C interface module 200a, SPI interface module 200b, or an interface module compliant with other interface protocols). Upon receiving the write command packet, the interface module 200 forwards it to the functional module 300. The write command packet contains a plurality of write commands, as illustrated in FIGS. 2 and 14.

The functional module 300 receives the write command packet and executes the plurality of write commands contained within it. The method for executing each write command is as follows:
The functional module 300 sends an I2C START to the remote I2C slave device 400, then the functional module 300 sends the remote I2C address byte to the remote I2C slave device 400, followed by sending 5 write commands to the remote I2C slave device 400.

For each byte sent by the functional module 300 to the remote I2C slave device 400, the functional module 300 receives the I2C acknowledgment bit from the remote I2C slave device 400 and determines the execution result of the write command.

The functional module 300 returns the write status packet to the interface module 200, including:
When the execution result of each write command included in the write command packet is success, the functional module 300 returns a write status packet with a success status to the interface module 200, and the interface module 200 returns the status information of the write status packet to the master controller 100.

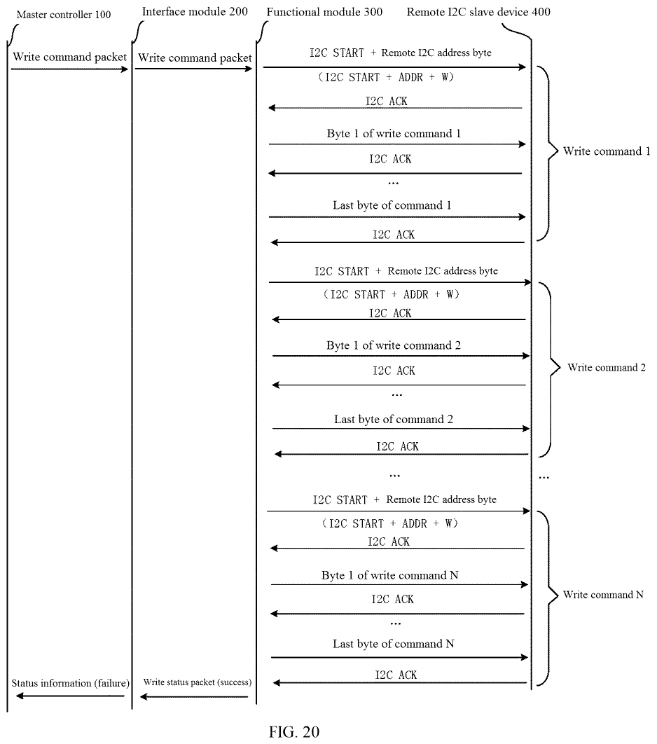

As shown in FIG. 20, for each write command (write command 1, write command 2, . . . , write command N) included in the write command packet, the functional module 300 first sends an I2C START to the remote I2C slave device 400, then sends the remote I2C address byte to the remote I2C slave device 400, and finally sends the write command to the remote I2C slave device 400. The remote I2C address byte consists of the I2C address (ADDR) and the write operation indicator bit (W).

For a write command, if the I2C acknowledgment bit received by the functional module 300 after sending the remote I2C address byte is I2C ACK, and the I2C acknowledgment bit received after sending each byte of the write command is I2C ACK, the execution result of this write command by the functional module 300 is success.

As shown in FIG. 20, when the execution result of each write command is success, the functional module 300 returns a write status packet with a success status to the interface module 200, and the interface module 200 returns the status information of the write status packet to the master controller 100.

In other embodiments (not shown in FIG. 20), the functional module 300 may also agree with the remote I2C slave device 400 that for a write command, if the I2C acknowledgment bit received after sending the remote I2C address byte is I2C ACK, and the I2C acknowledgment bit received after sending each byte of the write command except the last one is I2C ACK, while the I2C acknowledgment bit received after sending the last byte is I2C NAK, the functional module 300 still considers the execution result of this write command to be successful.

When the execution result of a write command fails, the functional module 300 stops executing subsequent write commands and returns a write status packet with a failure status to the interface module 200, which then returns the status information of the write status packet to the master controller 100.

As shown in FIG. 21, when the functional module 300 sends the remote I2C address byte (write command 1 address byte) to the remote I2C slave device 400, and the functional module 300 receives an I2CNAK as the I2C acknowledgment bit from the remote I2C slave device 400, the execution result of write command 1 is a failure. The functional module 300 stops executing subsequent write commands and returns a write status packet with failed status information to the interface module 200. The interface module 200 then relays the status information of the write status packet back to the master controller 100.

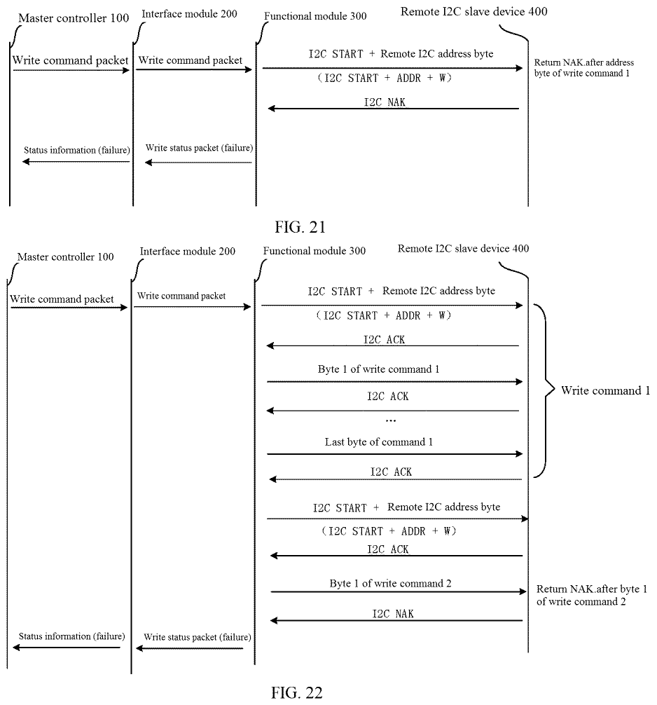

As shown in FIG. 22, another embodiment of a failed write command execution is presented. After the functional module 300 sends the remote I2C address byte, the received I2C acknowledgment bit is I2C ACK. Additionally, after the functional module 300 sends each byte of write command 1, the received I2C acknowledgment bit is I2C ACK, and the execution result of write command 1 by the functional module 300 is success. Then, for write command 2, after the functional module 300 sends the remote I2C address byte, the received I2C acknowledgment bit is I2C ACK. However, after the functional module 300 sends byte 1 of write command 2, the I2C acknowledgment bit received from the remote I2C slave device 400 is NAK, resulting in the execution result of write command 2 being a failure (in this embodiment, byte 1 of write command 2 is not the last byte of write command 2, or byte 1 is the last byte but the functional module 300 and the remote I2C slave device 400 agree that every byte of a write command must receive an I2C ACK for the command to be considered successful). Therefore, if at least one write command in the write command packet fails, the functional module 300 returns a write status packet with a failed status to the interface module 200, which then relays the status information to the master controller 100.

When at least one write command in the write command packet fails, the functional module 300 returns a write status packet with a failed status to the interface module 200, which then relays the status information to the master controller 100.

In the embodiments shown in FIGS. 21 and 22, when a write command fails, the functional module 300 stops executing subsequent write commands and returns a write status packet with a failed status to the interface module 200, which then relays the status information to the master controller 100. In other embodiments, when a write command fails, the functional module 300 may choose to continue executing subsequent write commands in the packet. However, if at least one write command fails, the functional module 300 returns a write status packet with a failed status to the interface module 200, which then relays the status information to the master controller 100.

In a preferred embodiment, the functional module 300 includes a remote I2C address register. The I2C address (e.g., ADDR as shown in FIGS. 20, 21 and 22) contained in the remote I2C address byte sent by the functional module 300 to the remote I2C slave device 400 is the remote I2C address stored in the register.

In a preferred embodiment, the write command packet includes a remote I2C address (as shown in FIGS. 2 and 14, where the packet contains a remote I2C address). The I2C address in the remote I2C address byte sent by the functional module 300 to the remote I2C slave device 400 is the remote I2C address included in the write command packet.

Furthermore, the functional module 300 includes a remote I2C address register. The functional module 300 also includes a remote I2C address selection module. The I2C address contained in the remote I2C address byte sent by the functional module 300 to the remote I2C slave device 400 is sourced either from the remote I2C address stored in the remote I2C address register or from the remote I2C address included in the write command packet, as indicated by the remote I2C address selection module.

In a preferred embodiment, the plurality of write commands in the write command packet each include a remote I2C address. The remote I2C address contained in the remote I2C address byte sent by the functional module 300 to the remote I2C slave device is sourced from the remote I2C address included in each respective write command.

It should be noted that the present disclosure does not limit the format of write command 1, write command 2, . . . , write command N, nor does it restrict the method used to determine the length of write command 1, write command 2, . . . , write command N. Regardless of the format employed for write command 1, write command 2, . . . , write command N, they all fall within the scope of protection of the present disclosure.

Although embodiments of the present disclosure have been shown and described above, it should be understood that these embodiments are exemplary and should not be construed as limiting the present disclosure. Variations, modifications, substitutions, and adaptations made by those skilled in the art within the scope of the present disclosure are all encompassed by the protection scope of the present disclosure.

What is claimed is:

1. A method for writing data to a remote I2C slave device of an interface system, wherein the interface system is configured to write data to the remote I2C slave device, the method comprising:
providing the interface system, comprising a master controller, an interface module, a functional module and the remote I2C slave device, wherein the master controller is connected to the interface module, the interface module is connected to the functional module, and the functional module is connected to the remote I2C slave device;
the master controller sending a write command packet to the interface module, and upon receiving the write command packet, the interface module forwarding the write command packet to the functional module,
wherein the write command packet contains a plurality of write commands, and the functional module receives the write command packet and executes the plurality of write commands contained therein, wherein a method for executing each write command is as follows:
the functional module sending an I2C START to the remote I2C slave device, then the functional module sending a remote I2C address byte to the remote I2C slave device, followed by the functional module sending the write command to the remote I2C slave device;
for each byte sent by the functional module to the remote I2C slave device, the functional module receiving an I2C acknowledgment bit from the remote I2C slave device and determining an execution result of the write command,
the functional module returning a write status packet to the interface module, comprising:
when the execution result of each write command in the write command packet is success, the functional module returning a write status packet with status information indicating success to the interface module;
when the execution result of at least one write command in the write command packet is failure, the functional module returning a write status packet with status information indicating failure to the interface module; and
the interface module returning the status information of the write status packet to the master controller.

2. The method according to claim 1, wherein the functional module receives the write command packet and executes the write commands contained therein; and when a execution result of a write command is failure, the functional module stops executing subsequent write commands and returns a write status packet with status information indicating failure to the interface module.

3. The method according to claim 1, wherein the master controller is an I2C master controller, and the interface module is an I2C interface module;
the I2C master controller is connected to the I2C interface module via an I2C clock line and an I2C data line; the I2C master controller initiates an I2C write operation to send the write command packet to the I2C interface module; and upon receiving the write command packet, the I2C interface module pulls down a leve of the I2C clock line and forwards the write command packet to the functional module;
the functional module returns the write status packet to the I2C interface module, and the I2C interface module then relays the status information of the write status packet back to the I2C master controller, comprising:
when the I2C interface module receives the write status packet and the status information of the write status packet indicates success, the I2C interface module stops pulling down the level of the I2C clock line and returns an I2C ACK to the I2C master controller; and
when the I2C interface module receives the write status packet and the status information of the write status packet indicates failure, the I2C interface module stops pulling down the level of the I2C clock line and returns an I2C NAK to the I2C master controller.

4. The method according to claim 1, wherein the master controller is an I2C master controller, and the interface module is an I2C interface module;
the I2C master controller is connected to the I2C interface module via an I2C clock line and an I2C data line; the I2C master controller initiates an I2C write operation to send the write command packet to the I2C interface module; and upon receiving the write command packet, the I2C interface mode forwards the write command packet to the functional module;
the functional module returns the write status packet to the I2C interface module, and the I2C interface module then relays the status information of the write status packet back to the I2C master controller, comprising:
after the I2C interface module receives the write command packet,
if a subsequent I2C operation initiated by the I2C master controller is an I2C write operation, and the I2C interface module receives the write status packet returned by the functional module with status information thereof indicating success, the I2C interface module proceeding to accept the subsequent I2C write operation initiated by the I2C master controller;
if the subsequent I2C operation initiated by the I2C master controller is an I2C write operation, and the I2C interface module receives the write status packet returned by the functional module to the I2C interface module with status information thereof indicating failure, then the I2C interface module returning an I2C NAK to the I2C master controller; and
if the subsequent I2C operation initiated by the I2C master controller is an I2C read operation, and the I2C interface module receives the write status packet returned by the functional module to the I2C interface module, then the I2C interface module returning the status information of the write status packet to the I2C master controller.

5. The method according to claim 1, wherein the master controller is an SPI master controller, the interface module is an SPI interface module, and the SPI master controller is connected to the SPI interface module via a SPI_CK signal line, a SPI_MOSI signal line and a SPI_MISO signal line;
the SPI master controller generates a clock edge on the SPI_CK signal line and sends the write command packet to the SPI interface module via the SPI_MOSI signal line; the write command packet begins with a first identifier; and upon receiving the write command packet from SPI_MOSI, the SPI interface module forwards the write command packet to the functional module; and
the functional module returns the write status packet to the SPI interface module, and the SPI interface module returns the status information of the write status packet to the SPI master controller, comprising:
upon receiving the write status packet, when the SPI master controller generates a clock edge on SPI_CK, the SPI interface module sending a write feedback packet to the SPI master controller via the SPI_MISO signal line, wherein the write feedback packet begins with a second identifier and contains the status information comprised in the write status packet.

6. The method according to claim 5, wherein the SPI master controller generates a clock edge on the SPI_CK signal line and reads the write feedback packet via the SPI_MISO signal line; and
if the SPI interface module does not receive the write status packet, the SPI interface module sends data unrecognizable as the write feedback packet to the SPI master controller via the SPI_MISO signal line.

7. The method according to claim 5, wherein the SPI master controller generates a clock edge on the SPI_CK signal line and sends the write command packet to the SPI interface module via the SPI_MOSI signal line; and
then, the SPI master controller generates a clock edge on the SPI_CK signal line and reads the write feedback packet via the SPI_MISO signal line, and after sending the write feedback packet via SPI_MISO, the SPI interface module can continue to receive subsequent command packets.

8. The method according to claim 5, wherein the write feedback packet is divided into a write success feedback packet and a write failure feedback packet;
the SPI master controller generates a clock edge on the SPI_CK signal line and reads the write feedback packet through the SPI_MISO signal line,
when the SPI interface module receives the write status packet and the status information contained in the write status packet indicates success, the SPI interface module sends the write success feedback packet through the SPI_MISO signal line, and the write success feedback packet begins with a third identifier; and
when the SPI interface module receives the write status packet and the status information contained in the write status packet indicates failure, the SPI interface module sends the write failure feedback packet through the SPI_MISO signal line, and the write failure feedback packet begins with a fourth identifier.

9. The method according to claim 1, wherein the functional module comprises a remote I2C address register, and an I2C address contained in the remote I2C address byte sent by the functional module to the remote I2C slave device is a remote I2C address stored in the remote I2C address register.

10. The method according to claim 1, wherein the write command packet contains a remote I2C address, and the I2C address contained in the remote I2C address byte sent by the functional module to the remote I2C slave device is the remote I2C address contained in the write command packet.

11. The method according to claim 10, wherein the functional module comprises a remote I2C address register and a remote I2C address selection module, and the I2C address contained in the remote I2C address byte sent by the functional module to the remote I2C slave device, as instructed by the remote I2C address selection module, is derived from either the remote I2C address stored in the remote I2C address register or the remote I2C address contained in the write command packet.

12. The method according to claim 1, wherein the plurality of write commands in the write command packet each contain a remote I2C address, and the remote I2C address contained in the remote I2C address byte sent by the functional module to the remote I2C slave device is derived from the remote I2C address contained in each respective write command.
